(19) United States
(12) Patent Application Publication
(10) Pub. No.: US 2003/0187109 A1
(43) Pub. Date: Oct. 2, 2003

(54) Stabilising halogenated polymers with pyrroles or derivatives thereof and compositions containing them

(76) Inventor: Christian Prud'Homme, Lyon (FR)

Correspondence Address: Jean-Louis Seugnet, Rhodia Inc, Intellectual Property Department, 259 Prospect Plains Road CN 7500, Cranbury, NJ, 08512, US

(21) Appl. No.: 10/312,656

(22) PCT Filed: Jul. 3, 2001
(86) PCT No.: PCT/FR01/02126

(30) Foreign Application Priority Data
Jul. 4, 2000 (FR) 00/08682

(51) Int. Cl. C08K 5/34

(52) U.S. Cl. 524/104

(57) ABSTRACT

The present invention relates to a procedure for stabilising halogenated polymers using at least one compound chosen from the pyrroles or derivatives, carrying, in the α-position, nitrogen, a carboxylic acid function in acid or salified form, or a possibly substituted aryl radical. The invention also relates to a stabilizing composition comprising at least one pyrrole or derivative and at least one additive chosen from among the amino-uracyles, the dihydropyridines or their mixtures.

The present invention relates to a procedure for stabilizing halogenated polymers using at least one compound chosen from the pyrroles or derivatives, as well as a stabilizing composition containing at least one pyrrole or derivative and at least one additive chosen from the amino-uracyles, the dihydropyridines or mixtures of these.

Halogenated polymers, and especially chlorinated' polymers, necessitate the use of stabillization additives, which act during the moulding of the polymers, or else after the moulding of the latter (ageing). This is because these polymers are susceptible to heat and light. The sensitivity to heat is manifested by a degradation of the coloration of the piece of polymer, which passes from a colour that is initially light (white to light yellow) to brown, then to black.

Up to now numerous additives have been developed with the aim of stabilizing halogenated polymers. The use of the carboxylates of alkaline-earthy metals (calcium) and/or transitional metals (zinc), compounds of the organo-tin type, or else lead-based, is thus known. These additives have likewise been used in combination with other compounds, such as, for example, organic compounds of the β-diketone or β-ketoester types, phosphites, hydrotalcites etc.

One of the aims of the present invention is to propose a means of stabilizing halogenated polymers not using additives containing metals, or having a lower content than that normally used in this field.

Thus the present invention relates to a procedure for stabilizing a halogenated polymer used in the absence of metallic stabilizer or in the presence of at least one metallic stabilizer with a total content lower than or equal to 100 ppm, expressed in relation to the metal, per 100 g of halogenated polymer, in which at least one compound of the following formula is used:

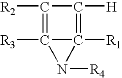

in which:

R₁ represents a carboxylic function in acid or salified form, an aryl radical, possibly carrier of at least one alkyl, hydroxyalkyl, alcoxy or hydroxyl radical

R₂ and R₃, identical or different, each represent one hydrogen atom, one halogen atom, one alkyl radical, one cycloalkyl radical and one aryl radical, the said radicals possibly being interrupted by at least one —O—, —S—, or —CO— group, or possibly being carriers of at least one —OH, —OR, or —SR function, with R representing an alkyl radical;

R₂ and R₃ may possibly be linked to each other in such a way that an aromatic cycle may or may not be formed, which is possibly a carrier of at least one alkyl radical and/or at least one one —OH, —OR, or —SR function, with R representing an alkyl radical;

R₄ represents a hydrogen atom and an alkyl radical.

Another aim of the present invention is a stabilizing composition for halogenated polymers comprising at least one compound, whose formula has just been detailed, and at least one additive chosen from the amino-uracyls or dihydropyridines; on condition that when R₂ and R₃ are linked to each other to form a phenyl radical, possibly carrier of an alkyl radical or an alcoxy radical, and R₁ represents a phenyl radical, possibly carrier of at least one alkyl, hydroxalkyl or hydroxyl radical, then the additive is chosen from the amino-uracyls. It has been found, completely unexpectedly, that the use of this type of organic compound (pyrrole or derivate) has made it possible to increase the colour stability of the halogenated polymer. In other words, the period during which no strong degradation of the coloration is observed, is extended in comparison with that measured when the usual organic stabilizers, which are free from metallic stabilizers, are utilized.

Furthermore, this effect is intensified when the pyrrole described is used in combination with at least one additive chosen from the amino-uracyls and/or the dihydropyridines. There is, in effect, a very distinct synergy between these two types of compounds, as, in this case, the stability performances achieved with the two compounds combined are better than those measured for one or other compound used separately; the total content of pyrrole-type compound and of additive being the same as that used with each of them taken separately.

But other characteristics and advantages of the present invention will appear more clearly on reading the description and examples that follow.

As indicated above, the present invention has as its aim a procedure for stabilizing halogenated polymers.

More particularly, the present invention is suitable for stabilizing chlorinated polymers, such as polyvinyl chloride (PVC).

Generally, any type of PVC is suitable, whatever its method of preparation: mass, suspension, emulsion or any other type of polymerization, and whatever its intrinsic viscosity.

The homopolymers of vinyl chloride can also be chemically modified, for example by chlorination.

Many vinyl chloride copolymers can also be stabilized against the effects of heat, i.e. yellowing and degradation.

These include in particular copolymers obtained by copolymerization of the vinyl chloride with other monomers having a polymerizable ethylenic bond, such as, for example vinyl acetate or vinylidene chloride: maleic and fumaric acids and/or their esters; olefins such as ethylene, propylene and hexene; acrylic or methacrylic esters; styrene, and vinylic ethers such as vinyldodecyl ether.

Usually these copolymers contain at least 50% by weight vinyl chloride units and preferably at least 80% by weight vinyl chloride units.

Compositions capable of being stabilized according to the procedure of the invention can also contain chlorinated-polymer-based mixtures containing a minority of quantities of other polymers, such as halogenated polyolefins or acrylonitrile/budadiene/styrene copolymers.

PVC alone, or in a mixture with other polymers, is the chlorinated polymer most widely used in the invention.

The stabilized compositions according to the invention can be rigid formulations, i.e. without plasticizer, or semi-rigid, i.e. with reduced plasticizer contents, such as those used in construction, the manufacture of various sections, or electric cabling, or for compositions containing only additives approved for contact with food, and for the manufacture of bottles.

These formulations very often contain a shock reinforcer such as a methacrylate/butadiene/styrene copolymer, for example.

They can also be plasticized formulations such as those utilized for the production of films for agricultural use.

The plasticizers used have known compounds such as, for example, alkyl phthalates. The plasticizer most often used is di(ethyl-2-hexyl) phthalate (usually known as dioctyl phthalate).

When the compositions contain a plasticizer, its content is generally from 5% to 120% by weight in relation to the weight of the chlorinated polymer.

The procedure according to the invention is thus carried out using at least one compound of the following formula:

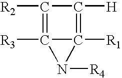

in which:

R₁ represents a carboxylic function in acid or salified form, an aryl radical, possibly carrier of at least one alkyl, hydroxyalkyl, alcoxy or hydroxyl radical

R₂ and R₃, identical or different, each represent one hydrogen atom, one halogen atom, one alkyl radical, one cycloalkyl radical and one aryl, arylalkyl or alkylaryl radical, the said radicals possibly being interrupted by at least one —O—, —S—, or —CO— group, or possibly being carriers of at least one —OH, —OR, or —SR function, with R representing an alkyl radical;

R₂ and R₃ may possibly be linked to each other in such a way that an aromatic cycle may or may not be formed, which is possibly a carrier of at least one alkyl radical and/or at least one —OH, —OR. or —SR function, with R representing an alkyl radical;

R₄ represents a hydrogen atom and an alkyl radical.

It should be noted that if R₁ represents a phenyl radical, then R₃ is preferably different from a phenyl radical.

The term “carboxylic function” is used to refer to the —COOA function, in which A represents a hydrogen atom or an alkaline, or alkaline-earthy metal such as sodium, and particularly calcium. If it is specified that A is calcium, the content of the above-mentioned compound, in the form of a calcium salt, is such that the total calcium content, expressed as a metal, is less than or equal to 100 ppm. More particularly, the carboxylic function is in the form of an acid, or of a sodium salt. Preferably, the carboxylic function is in the form of an acid.

In the case where R₁ represents an aryl radical, this corresponds more particularly to a phenyl radical, possibly carrier of at least one alkyl, hydroxyalkyl or alcoxy radical, in which the number of carbon atoms is between 1 and 20, and/or at least one hydroxyl radical. For example, the said aryl radical may possibly include one or more hydroxyl groups, one or more alkyl radicals, such as methyl, ethyl, propyl, butyl, hexyl, decyl, undecyl, dodecyl, lauryl, oleyl or stearyl and their isomers, as well as alkyl radicals chosen from those indicated above, carriers of at least one hydroxyl group; or else alcoxy radicals, such as methoxy.

According to a first particular embodiment of the invention, the above-mentioned compound is such that R₂ and R₃, identical or different, each represent one hydrogen atom, one halogen atom (preferably chlorine), one alkyl radical in C₁-C₂₀, one cycloalkyl radical in C₃-C₈, preferably in C₃₋₆, the said radicals possibly being interrupted by at least one —O—, —S—, or —CO-group, or possibly being carriers of at least one —OH, —OR. or —SR function with R representing an alkyl radical in C₁-C₂₀.

R₂ and R₃, identical or different, may also represent an aryl, alkylaryl or arylalkyl radical, for which the aryl part includes less than 14 carbon atoms, and preferably 6 carbon atoms, and the alkyl part is in C₁-C₂₀, possibly being interrupted by at least one —O—, —S—, or —CO— group, the said radicals possibly being carriers of at least one —OH, —OR, or —SR function with R representing an alkyl radical in C₁-C₂₀.

Preferably, the said radicals, whether or not identical, represent hydrogen, one alkyl radical, such as methyl, ethyl, propyl, butyl, hexyl, decyl, undecyl, dodecyl, lauryl, or stearyl and their isomers, as well as these same radicals which are carriers of at least one hydoxyl group, these radicals being chosen from the methoxy, ethoxy, thiomethyl and thioethyle radicals. The radicals, whether identical or not, can likewise represent an aryl radical, such as the phenyl radical, possibly carrier of one or more hydroxyl groups, of one or more alkyl radicals in C₁C₂₀, such as methyl, ethyl, propyl, butyl, hexyl, decyl, undecyl, dodecyl, lauryl, or stearyl and their isomers, as well as alkyl radicals which are carriers of at least one hydroxyl group, or else alcoxy radicals, such as methoxy, and ethoxy, or thioether radicals such as thiomethyl or thioethyl.

This first family defines compounds of the pyrrole type.

A second particular embodiment of the invention is made up of compounds in which R₂ and R₃ are linked to each other to form a phenyl radical, which is possibly carrier of at least one alkyl radical in C₁-C₂₀, and/or at least one —OH, —OR, or —SR function with R representing an alkyl radical in C₁-C₂₀.

In the latter case, the family defined here is that of the indoles. In the following, these two families will be referred to by the terms “pyrroles” and “derivatives”.

In addition, and whatever the embodiment chosen, R₄ represents a hydrogen atom or an alkyl radical in C₁-C₂₀, such as methyl, ethyl, propyl, butyl, hexyl, decyl, undecyl, dodecyl, lauryl, or stearyl and their isomers. Preferably, R₄ represents a hydrogen atom.

The stabilizing compounds used in the invention, apart from the fact that they form part of the pyrroles or derivatives, have the characteristic of carrying, in the α-position, nitrogen, a carboxylic acid function in acid or salified form, or a possibly substituted aryl radical, as described above.

It should be noted that use of a mixture of several compounds as just described would not go beyond the framework of the present invention, particularly a mixture of compounds in acid and salified form, whether or not these form part of the same embodiment.

According to a very advantageous embodiment of the present invention, the stabilizing compound is chosen from the pyrrole family.

The stabilizing compound content is more particularly between 0.005 and 5% by weight in relation to the weight of the halogenated polymer. Preferably, this content is between 0.5 and 5% by weight in relation to the weight of the halogenated polymer.

The above-mentioned compounds, whether from the pyrrole or the indole family, are well-known compounds. As for the preparation of the compounds carrying a carboxylic function in the α position of the nitrogen, a method to obtain these consists of bringing the compound into contact with a base of the sodium- or potassium-hydroxide type, then carbonating the resultant compound (by bubbling carbon dioxide for example). The final product can then be acidified by means of an acid, for example hydrochloric acid.

According to one very advantageous embodiment of the present invention, the stabilizing compound is used in combination with at least one additive chosen from the amino-uracyls and the dihydropyridines.

These two types of additives are well known in the field of stabilization of halogenated polymers.

More particularly, compounds are used of the 6-amino-uracyl type, carrying, in positions 1 and 3, substituents which may or may not be identical, of the alkyl type, more particularly in C₁-C₂₁, the aryl type, more particularly in C₆-C₁₂, or the arylalkyl type in C₇-C₂₁.

Furthermore, the amino group may be primary or secondary. In the latter case, the radical carried by the nitrogen can be chosen from the alkyl radicals in C₁-C₈, the cycloalkyl radical in C₅-C₈, more particularly the phenyl, alkylaryl benzenes such as benzyl, these radicals possibly being interrupted by at least one O—or —S— function, and/or possibly being carrier of at least one hydroxyl group.

As regards the dihydropyridines, substituted dihydropyridines are more particularly used, such as for example the 2.6-dimethyl 3.5-dicarboxylate 1.4 dihydropyridines. The carboxylate radicals of the ROCO— formula, which may or may not be identical, are preferably such that R represents an alkyl radical, linear or branched, in C₁-C₃₆; a cyclical radical having at least 14 carbon atoms and possibly carrying an ethylenic bond and/or at least one alkyl substituent in C₁-C₂₂: an aryl radical, having at least 14 carbon atoms (more particularly phenyl) and possibly carrying at least one alkyl substituent in C₁-C₂₂.

According to a preferred embodiment of the invention, the radical R is an alkyl radical.

The procedure according to the invention is more particularly carried out in the presence of an additive content between 0.005 and 5% by weight in relation to the weight of halogenated polymer. The additive content is preferably between 0.2 and 1.5% by weight in relation to the weight of halogenated polymer.

In the case of this variant utilizing at least one stabilizing compound of the pyrrole or derivative type, combined with at least one above-mentioned additive, the compound content can advantageously be between 0.1 and 3% by weight in relation to the weight of halogenated polymer. According to a preferred embodiment of this variant, the compound content is between 0.2 and 1.5% by weight in relation to the weight of halogenated polymer.

It should be noted, and this is quite remarkable, that the stabilization procedure according to the invention can be carried out, if not in the absence of metallic-type stabilizers, in the presence of small quantities of this type of stabilizer.

It is recalled that the metallic stabilizing compounds are compounds containing an alkaline-earthy metal or a metal chosen from Columns IIB, IIA, and IVB of the periodic table of the elements (published in the supplement to the Bulletin of the Société Chimique de France, no. 1, January 1966).

The metals are more particularly chosen from calcium, barium, magnesium, strontium, zinc, cadmium, tin or else lead.

It should be noted that associations can be envisaged such as, for example, mixtures with a base of calcium and zinc, barium and zinc, or barium and cadmium, the first combination being preferred.

As regards the organic-type compounds containing at least one of the elements in Columns IIB and IIA, mention can in particular be made of the salts of organic acids, such as aliphatic or aromatic carboxylic acids, or fatty acids. or else the phenolates or the aromatic alcoholates.

The most commonly used are for example salts of the IIA or IIB elements of the maleic. acetic, diacetic, propionic, hexanoic, ethyl-2 hexanoic, decanoic, undecanoic, lauric, myristic, palmitic, stearic, oleic, ricinoleic, behenic (docosanoic), hydroxystearic, hydroxy-undecanoic, benzoic, phenylacetic, paratertiobutylbenzoic and salicylic acids, the phenolates, the alcoholates derived from naphthol or phenols substituted by one or more alkyl radicals, such as nonylphenols.

As regards organic-type compounds containing lead, reference may in particular be made to those described in ENCYCLOPEDIA OF PVC by Leonard I NASS (1976) pages 299-303.

These are very diverse compounds, of which the most commonly used are dibasic lead carbonate, tribasic lead sulphate, tetrabasic lead sulphate, dibasic lead phosphate, lead orthosilicate, basic lead silicate, the coprecipitate of lead silicate and sulphate, basic lead chlorosilicate, the coprecipitate of silica gel and lead orthosilicate, dibasic lead phthalate, neutral lead stearate, dibasic lead stearate, tetrabasic lead fumarate, dibasic lead maleate, lead ethyl-2 hexanoate, and lead laurate.

With regard to tin-based compounds, reference may in particular be made to the work “PLASTICS ADDITIVES HANDBOOK” by GACHTER/MULLER (1985) pages 204-210 or ENCYCLOPEDIA OF PVC by Leonard I. NASS (1976) pages 313-325.

These are more particularly mono- or d-alkyl-tin carboxylates and mono- or di-alkyl tin mercaptides.

The most commonly used compounds include derivatives of di-n-methyl tin, di-n-butyl tin or di-n-octyl tin such as, for example, dibutyl tin dilaurate, dibutyl tin maleate, dibutyl tin dilaurate- maleate or dibutyl tin, bis(mono-C₄-C₈-alkyl maleate), dibutyl tin bis(lauryl-mercaptide), dibutyl tin S-S' (iso-octyl mercaptoacetate), dibutyl tin β-mercapto propionate, di-n-octyl tin polymer maleate, bis-S-S' (isooctyl mercaptoacetate)di-n-octyl tin, and di-n-octyl tin β-mercapto propionate. The monoalkyl derivatives of the above-mentioned compounds are also suitable.

Thus, in the case of one metallic stabilizer being utilized in the procedure according to the invention, the total content of this stabilizer is advantageously lower than or equal to 100 ppm, expressed in relation to the metal, per 100 g of halogenated polymer. More particularly, when this type of stabilizer is present, its total content is between o and 50 ppm per 100 g of halogenated polymer, lower limit excluded.

The procedure according to the invention can in addition be carried out in the presence of the stabilizers usual in the field.

As an example of mineral-type stabilizer, mention can be made of the sulphates and/or carbonates of aluminium and/or magnesium, particularly of the hydrotalcite type. It is recalled that the hydrotalcite-type compounds correspond to the following formula: Mg₁₋ₓAIₓ(OH)₂Aⁿ⁻_{x/n}. mH₂O, in which x is between 0 exclusive and 0.5, Aⁿ⁻ represents an anion such as, in particular, carbonate, n varies from 1 to 3 and m is positive. It should be noted that products of this type which have been subjected to surface treatment with an organic compound can be used. Likewise, use of a hydrotalcite-type product doped with zinc, having possibly, been subjected to a surface treatment with an organic compound would not go beyond the framework of the present invention. Among products of this type mention can be made in particular of Alcarnizer® 4 (marketed by the company Kyowa).

It is also possible to utilise essentially amorphous compounds of the formula (MgO)_{y}, Al₂O₃, (CO₂)ₓ, (H₂O)_{z}, in which x, y and z verify the following in equations: 0<x≦0.7; 0<y≦1.7; and z≧3. These compounds are in particular described in Patent Application EP 509 864. Moreover, the “catoïte” compounds with the formula Ca₃AI₂(OH)₁₂ or else Ca₃AI₂(SiO)₄(OH)₁₂ are suitable as mineral-type hydrochloric acid captor compounds.

If it is present, the content of this type of compound can vary between 0.05 and 2 g per 100 g halogenated polymer.

As organic-type stabilizers, mention may also be made of polyols comprising 2 to 32 carbon atoms and having 2 to 9 hydroxyl groups.

Amongst these compounds, mention may be made of the diols in C₃-C₃₀ such as propylene glycol, butanediol, hexanediol, dodecanediol, neopentyl glycol, polyols such as trimethylolpropane, pentaerythritol, dipentaerythritol, tripentaerythritol, xylitol, mannitol, sorbitol, glycerine, and mixtures of oligomers of the glycerine having a degree of polymerization of 2 to 10.

Another family of polyols suitable for use is the partially acetylated polyvinyl alcohols.

It is likewise possible to use hydroxylated compounds including isocyanurate groups, alone or in combination with the above-mentioned polyols, such as, for example, tris(2-hydroxyethyl) isocyanurate.

If they are present, the quantity of polyol and/or hydroxylated compounds used is generally between 0.05 and 5 g per 100 g of halogenated polymer. More particularly it is less than 2 g for 100 g of halogenated polymer.

It may also be possible to incorporate into the formulation organic phosphite-type compounds, such as, for example trialkyl, aryl, triaryl, dialkylaryl or diarylalkylphosphites, for which the term alkyl designates hydrocarbonated groups of monoalcohols or polyols in C₈-C₂₂, and the term aryl designates aromatic groups of phenol or phenol substituted by alkyl groups in C₆-C₁₂. It is also possible to use calciumphosphites, such as, for example, compounds of the Ca(HPO₃).(H₂O) type, as well as phosphite-hydroxy- aluminium-calcium complexes.

The content of additive of this type, if it is used, is normally between 0.1 and 2 g per 100 g of hydrogenated polymer.

It is likewise possible to use at least one aluminosilicate of alcaline, crystalline or synthetic metal, having a water content between 13 and 25% by weight, with the composition 0.7-1M₂O.AI₂O₃-1,3-2,4SiO₂ in which M represents an alkaline metal such as, in particular, sodium. NaA-type zeolites, as described in the U.S. Pat. No. 4,590,233 are particularly suitable.

When it is used, the content of this type of compound generally varies between 0.1 and 5 g per 100 g of hydrogenated polymer.

Epoxidated-type compounds can also be utilized. These compounds are generally chosen from the epoxidated polyglycerides, or epoxidated fatty acid esters, such as epoxidated linseed, soya or fish oils.

The quantity of these compounds, if they are present, normally varies between 0.5 and 10 g per 100 g of halogenated polymer.

Finally, among the traditional additives in the field, mention may be made of titanium dioxide. The titanium dioxide is preferably in rutile form.

Generally, the grain size of the titanium oxide included in the compositions according to the invention is between 0.1 and 0.5 μm.

According to one particular embodiment of the invention, titanium oxide in rutile form is used, which has been subjected to a surface treatment, preferably mineral, such as the titanium oxides Rhoditan® RL18, Rhoditan® RL90, marketed by Rhodia Chimie, and the titanium oxides Kronos 2081® and 2220® marketed by Kronos.

The halogenated polymer-based compositions can contain other white or coloured pigments. Among the coloured pigments, mention may be made of cerium sulphide in particular.

It should be noted that the quantity of pigment introduced into the formulation varies widely and depends in particular on the colouring power of the pigment and the final coloration desired. However, by way of example, and if it is contained in the polymeric composition, the quantity of pigment can vary from 0.1 to 20 g per 100 g of halogenated polymer, and preferably from 0.5 to 15 g in relation to the same reference.

Additives such as the phenolic antioxidants, anti-UV agents such as the 2-hydroxybenzophenones, 2-hydroxybenzotriazoles or sterically hindered amines, usually known as “Hals”, can be included in the halogenated polymer composition.

The content of this type of additive varies generally between 0.05 and 3 g per 100 g of hydrogenated polymer.

If necessary, it is also possible to use lubricants that will facilitate utilization, chosen in particular from the glycerol monostearates, or else propylene glycol, fatty acids or their esters, montanate waxes, polyethylene waxes or their oxidated derivatives, paraffins, metallic soaps, and functionalized polymethylsiloxane oils such as, for example, γ-hydroxypropylenated oils.

The quantity of lubricant contained in the halogenated polymer-based formulation generally varies between 0.05 and 2 g per 100 g of polymer.

The formulation can also include plasticizers chosen from the alkyl phthalates. The compounds more generally used are chosen from di(ethyl-2-hexyl) phthalate, linear diacid esters in C₆-C₁₂, trimellitates or ester phosphates.

The quantity of plasticizer used in the formulations varies widely, depending on the rigid or flexible nature of the final polymer. As an indication, the content varies from 0 to 100 g per 100 g of halogenated polymer.

The preparation of the formulations can be made by any method known to the expert.

It is thus possible to incorporate the various constituents into the polymer individually or after having first prepared a mixture of several of these constituents.

The traditional methods of incorporation are perfectly suitable for obtaining the PVC-based formulation.

Thus, and purely as an indication, this operation can be carried out in a mixer with a system of blades and counter-blades functioning at high speed.

Generally the mixing operation is carried out at a temperature below 130° C.

Once the mixture is completed, the composition is moulded according to the methods usual in the field, such as injection, extrusion-blow moulding, extrusion, calendering, or rotation moulding.

The temperature at which the moulding is carried out generally varies from 150 to 220° C.

Another aim of the present invention is a stabililizing composition for halogenated polymers comprising:

at least one additive chosen from the amino-uracyls or dihydropyridines, and

at least one compound of the following formula:

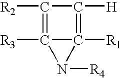

In which:

R₁ represents a carboxylic function in acid or salified form, an aryl radical, possibly carrier of at least one alkyl, hydroxyalkyl, alcoxy or hydroxyl radical

R₂ and R₃, identical or different, each represent one hydrogen atom, one halogen atom, one alkyl, alkylaryl or arylalkyl radical, one cycloalkyl radical or one aryl radical, the said radicals possibly being interrupted by at least one —O—, —S—, or —CO— group, or possibly being carriers of at least one —OH, —OR, or —SR function, with R representing an alkyl radical;

R₂ and R₃ may possibly be linked to each other in such a way that an aromatic cycle may or man not be formed, which is possibly a carrier of at least one alkyl radical and/or at least one one —OH. —OR, or —SR function, with R representing an alkyl radical;

R₄ represents a hydrogen atom and an alkyl radical.

Given that when R₂ and R₃ are linked to each other to form a phenyl radical, possibly carrier of an alkyl radical or an alcoxy radical, and R₁ represents a phenyl radical, possibly carrier of at least one alkyl, hydroxyalkyl, or hydroxyl radical, then the additive is chosen from the amino-uracyls.

The indications given above regarding the nature of each of the constitutive elements of this composition, and also their preferred variants, remain valid and will not be repeated here.

Moreover, the proportion in compound, in relation to the amino-uracyl or the dihydropyridiene, is between 20/80 and 80/20.

Concrete, but not exhaustive, examples of the invention will now be provided.

### EXAMPLES 1 TO 4

These examples are aimed at showing the effect of stabilizers according to the invention on the stability of coloration of PVC compositions.

a) Compositions

A basic formulation, whose composition is shown in the table below, is prepared.

| Composition | Parts by weight |
|---|---|
| PVC S 110 P KW=67 (1) | 100 |
| KM 355 Shock modifier (2) | 6 |
| Omyalit 95 CaCO₃ (3) | 5 |
| Loxiol G60 Lubricant (4) | 0.4 |
| Loxiol G20 Lubricant (4) | 0.2 |
| K 120 Processing aid (2) | 1 |
| Alcamizer 1 Hydrotalcite (5) | 0.6 |

(1) marketed by Elf Athochem
(2) marketed by Robm and Haas
(3) marketed by the company Omya
(4) marketed by Sidobre Sinova
(5) marketed by Kyowa Chemical Industry Co. Ltd

The following organic stabilizers are added to these compositions:

| Example | Stabilizer | Parts by weight |
|---|---|---|
| 1 - reference | No organic stabilizer | — |
| 2 - reference | Acetyl-2-pyrrole | 3 |
| 3 - invention | Pyrrole-2 carboxylic acid | 3 |
| 4 - invention | Phenyl-2-indole | 3 |

b) Preparation of the Samples

The samples are obtained by mixing the formulation for 10 minutes using a BRAUN laboratory mixer.

From the powders thus homogenized, leaves 1 mm thick are prepared by passing through a 2-cylinder mixer at 180° C. for 3 minutes, then the calendered leaves are pressed at 180° C. for 4 minutes.

From the leaves thus obtained, squares (7 cm×7 cm) are cut, and two squares are pressed at 180° C. so as to obtain one single leaf.

Test pieces circular in shape are then cut from this leaf (diameter approx. 1.5 cm).

c) Measurement of the Stability of the Coloration

For this purpose, the test pieces obtained are first arranged on a mobile tray, introduced into an oven at 180° C.

The test pieces are removed at regular intervals to carry out coloration measurements.

This makes it possible to obtain the thermal degradation of the test piece with reference to how long it has been in the oven at 180° C.

The thermal degradation is quantified with reference to the time taken for evolution of the colour of the sample measured using a MINOLTA CR300® calorimeter and expressed by its coordinates in the L*a*b* colour space (CIELAB).

Results

| | 1 - reference | | | 2 - reference | | | 3 - invention | | | 4 - invention | | |
|---|---|---|---|---|---|---|---|---|---|---|---|---|
| Min | L* | a* | b* | L* | a* | B* | L* | a* | b* | L* | a* | b* |
| 0 | 43.6 | 20.7 | 17.3 | 44.7 | 16.9 | 19.1 | 67.9 | −2.24 | 9.34 | 70.7 | −1.46 | 12.2 |
| 10 | 36.9 | 18.2 | 11.6 | 34.7 | 15.2 | 9.47 | 66.9 | −1.31 | 16.6 | 70.2 | −1.36 | 15.8 |
| 20 | 32.2 | 13.1 | 6.5 | 28.6 | 8.38 | 4.59 | 63.8 | −0.85 | 22.1 | 69.6 | −1.24 | 18.4 |
| 30 | 29.1 | 8.87 | 4.1 | 26.6 | 6.76 | 3.10 | 62.0 | −0.17 | 25.3 | 68.6 | −0.90 | 21.6 |
| 40 | 32.3 | 8.67 | 9.13 | 27.5 | 7.91 | 5.95 | 57.7 | 2.02 | 28.0 | 67.6 | −0.49 | 23.3 |
| 50 | 32.1 | 6.78 | 9.56 | 28.7 | 6.86 | 6.27 | 51.5 | 4.08 | 28.1 | 66.8 | 0.31 | 26.0 |
| 60 | 32.0 | 5.71 | 8.92 | 27.1 | 5.44 | 5.76 | 44.0 | 7.36 | 23 | 65.7 | 0.91 | 27.0 |

It is noted that at time 0, the test pieces according to the invention are lighter in colour than those of the references (high L). Moreover, the initial value of the a* and b* indices is distinctly lower than in the case of Examples 3 and 4. These results show that the initial coloration is considerably improved in comparison with the references.

Moreover, in the cases according to the invention, the coloration becomes more pronounced but only at the end of 60 minutes. Finally, after this period, the coloration of the test pieces according to the invention is less degraded than that of the reference examples.

### EXAMPLES 5 AND 6

These examples have the effect of showing the effect of synergy existing when pyrrole and indole-type compounds are combined with an amino-uracyl or a dihydropyridine.

The same procedure is followed as for the previous examples, except that the stabilizers used as follows:

| Example | Stabilizer | Parts by weight |
|---|---|---|
| 1 - reference | No organic stabilizer | — |
| 5 - invention | Pyrrole-2 carboxylic acid | 1 |
| 6 - invention | Pyrrole-2 carboxylic acid | 0.6 |
| | ADMU (*) | 0.4 |

(*) ADMU = amino-6 dimethyl-1,3 uracyl

The results are shown in the table below:

| Du- | | | | | | | | | |
|---|---|---|---|---|---|---|---|---|---|
| ration | 1 - reference | | | 5 - invention | | | 6 - invention | | |
| Min | L* | a* | b* | L* | A* | b* | L* | a* | b* |
| 0 | 43.6 | 20.7 | 17.3 | 69.6 | −3.24 | 18.7 | 72.5 | −2.52 | 10.3 |
| 10 | 36.9 | 18.2 | 11.6 | 66.8 | −0.39 | 27.2 | 72.2 | −2.86 | 14.5 |
| 20 | 32.2 | 13.1 | 6.5 | 62.3 | 3.51 | 33.6 | 71.9 | −3.15 | 17.8 |
| 30 | 29.1 | 8.87 | 4.1 | 57.9 | 7.36 | 35.1 | 71.3 | −3.15 | 21.7 |
| 40 | 32.3 | 8.67 | 9.13 | 53.1 | 10.1 | 34.1 | 69.7 | −2.85 | 27.4 |
| 50 | 32.1 | 6.78 | 9.56 | 46.7 | 11.3 | 28.3 | 53.7 | 11.0 | 31.5 |

Initally, Examples 5 and 6 according to the invention considerably improve the results obtained in comparison with the reference.

Moreover, with an identical stabilizer content, in the case of Example 6, it is noted that the initial coloration is not degraded and that the stability of the coloration is considerably improved.

1. Procedure for stabilizing a halogenated polymer used in the absence of metallic stabilizer or in the presence of a metallic stabilizer with a total content less than or equal to 100 ppm, expressed in relation to the metal, per 100 g of halogenated polymer, in which at least one compound with the following formula is used: 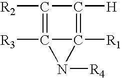
in which:
R₁ represents a carboxylic function in acid or salified form, an aryl radical, possibly carrier of at least one alkyl, hydroxyalkyl, alcoxy or hydroxyl radical;
R₂ and R₃, identical or different, each representing one hydrogen atom, one halogen atom, one alkyl radical, one cycloalkyl radical or one aryl, alkylaryl or arylalkyl radical, the said radicals possibly being interrupted by at least one —O—, —S—, or —CO— group, or possibly being carriers of at least one —OH, OR, or SR function, with R representing an alkyl radical;
R₂ and R₃ may possibly be linked to each other in such a way that an aromatic cycle may or may not be formed, which is possibly a carrier of at least one alkyl radical and/or at least one one —OH, —OR, or —SR function, with R representing an alkyl radical;
R₄ represents a hydrogen atom and an alkyl radical.

2. Procedure according to the previous claim, characterized in that a compound is used, in which R₂ and R₃, identical or different, each represent one hydrogen atom, one halogen atom, one alkyl radical in C₁-C₆ and one cycloalkyl radical in C₃-C₈S, the said radicals possibly being interrupted by at least one —O—, —S—, or —CO— group, or possibly being carriers of at least one —OH, —OR, or —SR function, with R representing an alkyl radical in C₁-C₂₀; one aryl, alkylaryl. or aryalkyl radical, for which the aryl part contains at least 14 carbon atoms, and preferably 6 carbon atoms, and the alkyl part is in C₁-C₂₀, possibly interrupted by at least one —O—, —S—, or —CO— group; the said radicals possibly being carriers of at least one —OH, —OR or —SR function. With R representing an alkyl radical in C₁-C₂₀.

3. Procedure according to claim 1, characterized in that a compound is used, in which R₂ and R₃ are linked to each other to form a phenyl radical, possibly carrier of at least one alkyl radical and/or at least one —OH, —OR or —SR function, with R representing an alkyl radical in C₁-C₂₀.

4. Procedure according to any one of the previous claims, characterized in that R₄ represents one hydrogen atom.

5. Procedure according to any one of the previous claims, characterized in that a compound content is used, between 0.005 and 5% by weight in relation to the weight of the halogenated polymer, preferably between 0.5 and 5% by weight in relation to the weight of the halogenated polymer.

6. Procedure according to any one of the previous claims, characterized in that an additive is used, chosen from the amino-uracyls, corresponding to the 6-amino-uracyles, carrying in positions 1 and 3 substituents that may or may not be identical, of the alkyl type, more particularly in C₁-C₂₁, aryl type, more particularly in C₆-C₁₂, or of the arylalkyl type in C₇-C₂₁; the amino group being primary or secondary, in which the radical carried by the nitrogen is chosen from the alkyl radicals in C₁-C₈, cycloalkyl radicals in C₅-C₈, aryl or alkylaryl radicals; these radicals may possibly be interrupted by at least one —O—or —S— function, and/or possibly be carriers of at least one hydroxyl group.

7. Procedure according to one of the previous claims, characterized in that an additive is used, chosen from the dihydropyridines, more particularly the substituted dihydropyridines corresponding to 2,6-dimethyl 3,5-dicarboxylate 1,4 dihydropyridines, whose carboxylate radicals of ROCO— formula which may or may not be identical, are preferably such that R represents an alkyl radical, linear or branched, in C₁-C₃,; a cyclical radical having at less than 14 carbon atoms and possibly carrying an ethylenic bond and/or at least one alkyl subsituent in C₁-C₂₂; an aryl radical, having at least 14 carbon atoms and possible carrying at least one alkyl substituent in C₁-C₂₂.

8. Procedure according to the previous claim, characterized in that an additive content is used, between 0.005 and 5% by weight in relation to the weight of halogenated polymer. preferably between 0.2 and 1.5% by weight in relation to the weight of halogenated polymer.

9. Procedure according to any one of claims 6 to 8, characterized in that a compound content is used, between 0.1 and 3% by weight in relation to the weight of the halogenated polymer, preferably between 0.2 and 1.5% by weight in relation to the weight of the halogenated polymer.

10. Stabilizing composition for halogenated polymer comprising:
at least one additive chosen from the amino-uracyls or the dihydropyridines, and
at least one compound of the following formula: 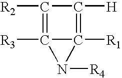
in which:
R₁ represents a carboxylic function in acid or salified form, an aryl radical, possibly carrier of at least one alkyl, hydroxyalkyl, alcoxy or hydroxyl radical
R₂ and R₃, identical or different, each represent one hydrogen atom, one halogen atom, one alkyl radical, one cycloalkyl radical or one aryl, alkylaryl or arylalkyl radical, the said radicals possibly being interrupted by at least one —O—, —S—, or —CO— group, or possibly being carriers of at least one —OH, OR, or SR function, with R representing an alkyl radical;
R₂ and R₃ may possibly be linked to each other in such a way that an aromatic cycle may or may not be formed. which is possibly a carrier of at least one alkyl radical and/or at least one one —OH, —OR, or —SR function, with R representing an alkyl radical:
R₁ represents a hydrogen atom and an alkyl radical;
Given that when R₂ and R₃ are linked to each other so as to form a phenyl radical, possibly carrier of an alkyl or an alcoxy radical and R₁ represents a phenyl radical, possibly carrier of at least one alkyl, hydroxyalkyl, or hydroxyl radical, then the additive is chosen from the amino-uracyls.

11. Stabilizing composition according to the previous claim, characterized in that the amino-uracyls correspond to the 6-amino-uracyls carrying, in positions 1 and 3, substituents, that may or may not be identical, of the alkyl type, more particularly in C₁-C₂₁, aryl type, more particularly in C₆-C₁₂, or of the arylalkyl type in C₇-C₂₁; the amino group being primary or secondary, in which the radical carried by the nitrogen is chosen from the alkyl radicals in C₁-C₈, cycloalkyl radicals in C₅-C₈, aryl or alkylaryl radicals; these radicals possibly being interrupted by at least one —O— or —S— function, and/or possibly being carriers of at least one hydroxyl group.

12. Stabilizing composition according to either of claims 10 or 11, characterized in that the dihydropyridines are chosen from the substituted dihydropyridines corresponding to 2,6-dimethyl 3,5-dicarboxylate 1,4 dihydropyridines, whose carboxylate radicals, of the ROCO— formula which may or may not be identical, are preferably such that R represents an alkyl radical, linear or branched, in C₁-C₃₆; a cyclical radical having less than 14 carbon atoms and possibly carrying an ethylenic bond and/or at least one alkyl substituent in C₁-C₂₂: an aryl radical, having less than 14 carbon atoms and possibly carrying at least one alkyl substituent in C₁-C₂₂.

13. Composition according to any one of claims 10 to 12 characterized in that the proportion of compound, in relation to the amino-uracyl or the dihydropyridiene is between 20/80 and 80/20.
